(19) United States
(12) Patent Application Publication
(10) Pub. No.: US 2014/0131551 A1
(43) Pub. Date: May 15, 2014

(54) PROXIMITY SENSOR AND OPERATING METHOD THEREOF

(71) Applicant: uPI Semiconductor Corp., Zhubei City (TW)

(72) Inventors: Ping-Yuan Lin, Zhubei City (TW); Chih-Chang Wei, Zhubei City (TW)

(73) Assignee: uPI Semiconductor Corp., Zhubei City (TW)

(21) Appl. No.: 14/072,864

(22) Filed: Nov. 6, 2013

(30) Foreign Application Priority Data
Nov. 9, 2012 (TW) 101141851

(51) Int. Cl. G01S 7/497

(52) U.S. Cl. CPC G01S 7/497
USPC 250/206.1

(57) ABSTRACT

A proximity sensor includes a proximity sensing unit and a signal processing unit. The proximity sensing unit detects whether an object to be detected is close by to obtain a measured value. The signal processing unit compares the measured value with an initial noise cross-talk value to determine whether the initial noise cross-talk value should be updated. If the determined result of the signal processing unit is no, the signal processing unit compares the measured value with a default value to determine whether the object to be detected is located in a detection range of the proximity sensing unit.

### BACKGROUND OF THE INVENTION

1. Field of the Invention

The invention relates to a proximity sensor; in particular, to a proximity sensor and operating method thereof capable of effectively avoiding noise cross-talk.

2. Description of the Prior Art

In general, the ambient light sensor and proximity sensor are often used in current touch monitors. The ambient light sensor is capable of adjusting the brightness of the touch monitor according to the changing of the ambient light, so that power saving and eyes protection can be achieved. The proximity sensor senses whether an object or obstacle is in front by optical or electromagnetic means. In practical applications, the proximity sensor can be used in a smart phone or handheld device to determine whether the user is close by to answer or used in a domestic robot to determine whether any furniture or person is in front.

When the user is close by to answer the smart phone, the smart phone will shut down its touch functionality to avoid the monitor being carelessly touched by the face of the user. The current optical proximity sensor needs an infrared ray (IR) LED to detect the distance between the monitor and the face. However, the disadvantage of this design with an IR LED is that it increases the complexity level of the mechanical design. If the mechanical design is not well done, noise crosstalk will occur, which will in turn decrease the range that the proximity sensor can sense, and even causes malfunction of the system.

### SUMMARY OF THE INVENTION

Therefore, the invention provides a proximity sensor and operating method thereof to solve the above-mentioned problems occurred in the prior arts.

A scope of the invention is to provide a proximity sensor. In a preferred embodiment, the proximity sensor includes a proximity sensing unit and a signal processing unit. The proximity sensing unit detects whether an object to be detected is close by to obtain a measured value. The signal processing unit compares the measured value with an initial noise cross-talk value to determine whether the initial noise cross-talk value should be updated. If the determined result of the signal processing unit is no, the signal processing unit compares the measured value with a default value to determine whether the object to be detected is located in a detection range of the proximity sensing unit.

Another scope of the invention is to provide a proximity sensor operating method. In a preferred embodiment, the proximity sensor operating method includes steps of: (a) detecting whether an object is close by to obtain a measured value; (b) comparing the measured value with an initial noise cross-talk value to determine whether the initial noise cross-talk value should be updated; and (c) if the result determined by the step (b) is no, comparing the measured value with a default value to determine whether the object is located in a detection range of the proximity sensor.

Compared to the prior arts, the proximity sensor and the operating method thereof in the invention can effectively reduce the noise crosstalk effect caused by poor packaging or mechanical design, so that the proximity sensor of the invention will not malfunction due to misjudgment, and the sensing accuracy of the proximity sensor will be largely increased.

The advantage and spirit of the invention may be understood by the following detailed descriptions together with the appended drawings.

BRIEF DESCRIPTION OF THE APPENDED DRAWINGS

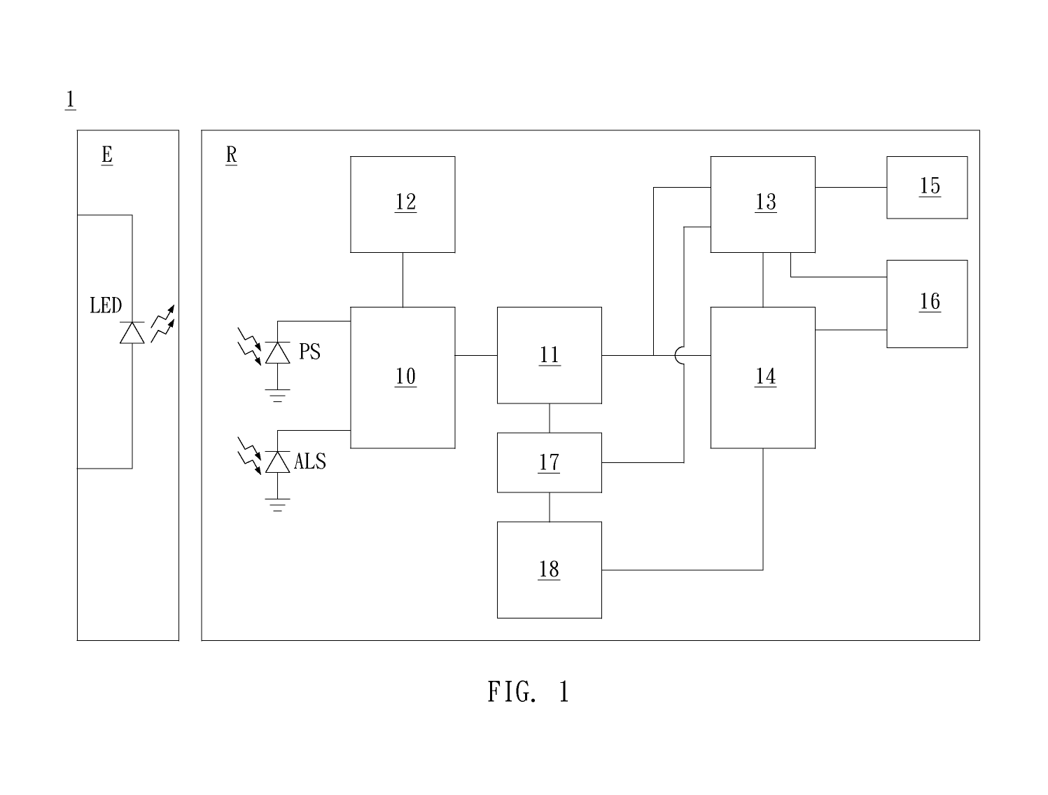

FIG. 1 illustrates a functional block diagram of a proximity sensor in an embodiment of the invention.

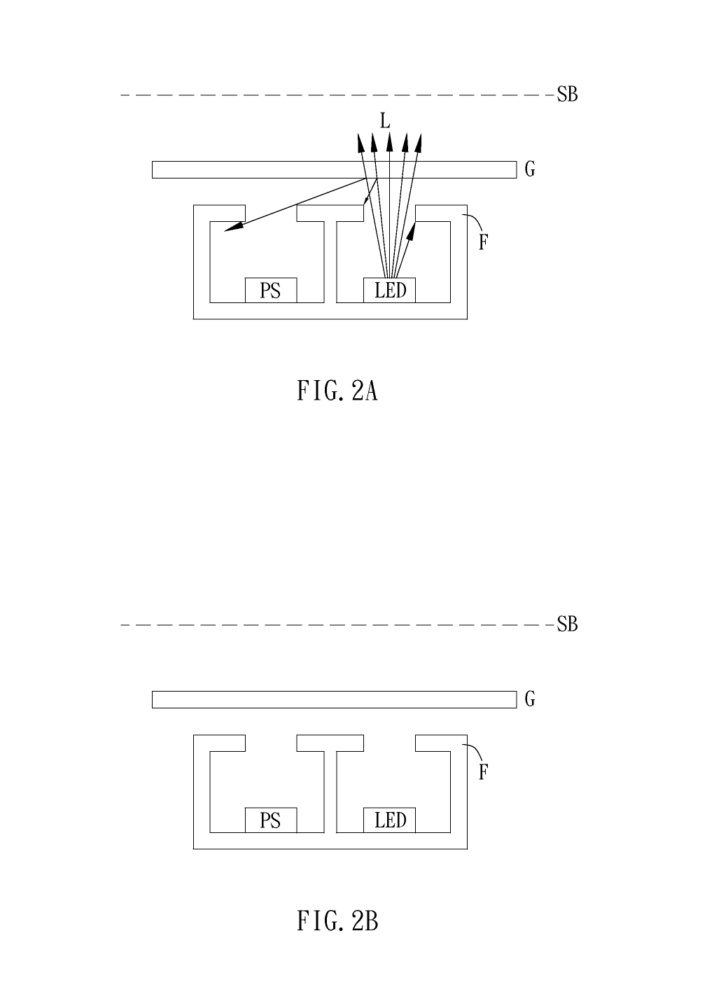

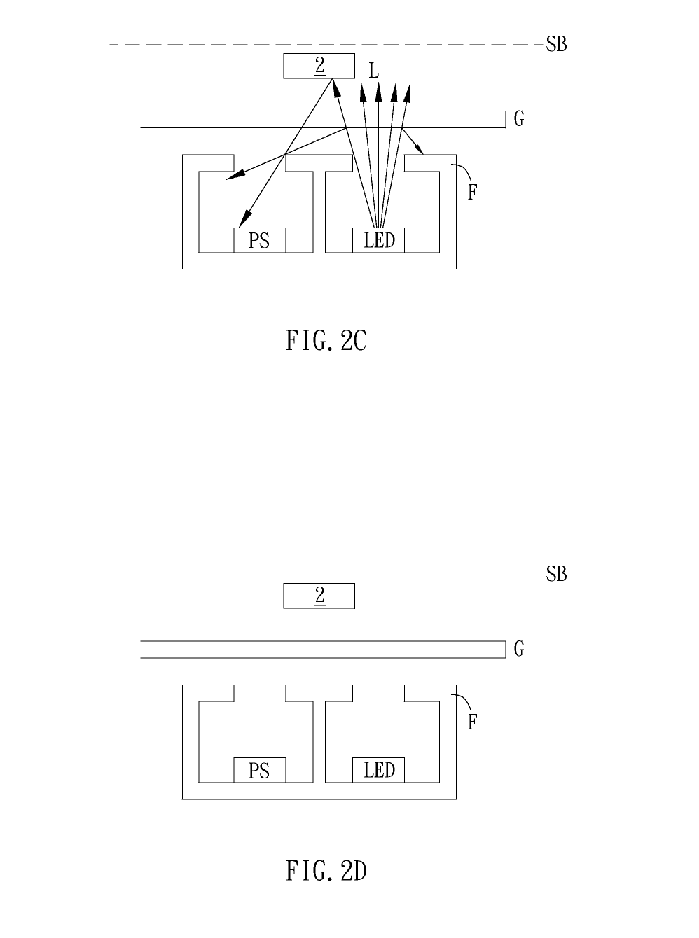

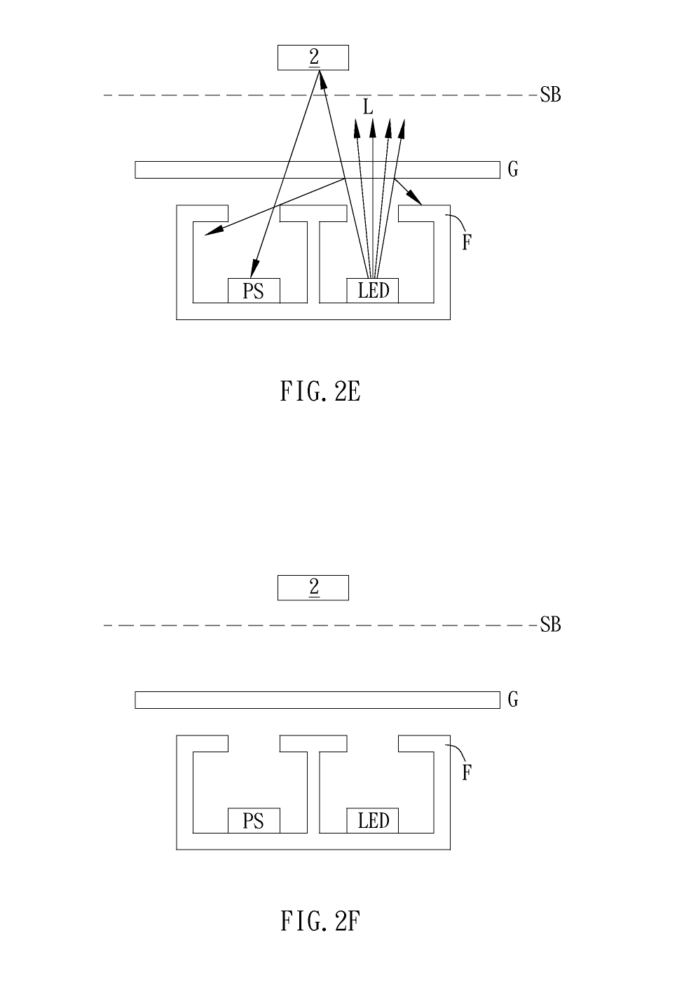

FIG. 2A illustrates a schematic diagram of the proximity sensing unit sensing when the LED is active and emits lights under the condition that no object is close by to the proximity sensor of the electronic apparatus.

FIG. 2B illustrates a schematic diagram of the proximity sensing unit sensing when the LED is inactive under the condition that no object is close by to the proximity sensor of the electronic apparatus.

FIG. 2C illustrates a schematic diagram of the proximity sensing unit sensing when the LED is active and emits lights under the condition that an object is located in the detection range of the proximity sensor.

FIG. 2D illustrates a schematic diagram of the proximity sensing unit sensing when the LED is inactive under the condition that an object is located in the detection range of the proximity sensor.

FIG. 2E illustrates a schematic diagram of the proximity sensing unit sensing when the LED is active and emits lights under the condition that an object is located out of the detection range of the proximity sensor.

FIG. 2F illustrates a schematic diagram of the proximity sensing unit sensing when the LED is inactive under the condition that an object is located out of the detection range of the proximity sensor.

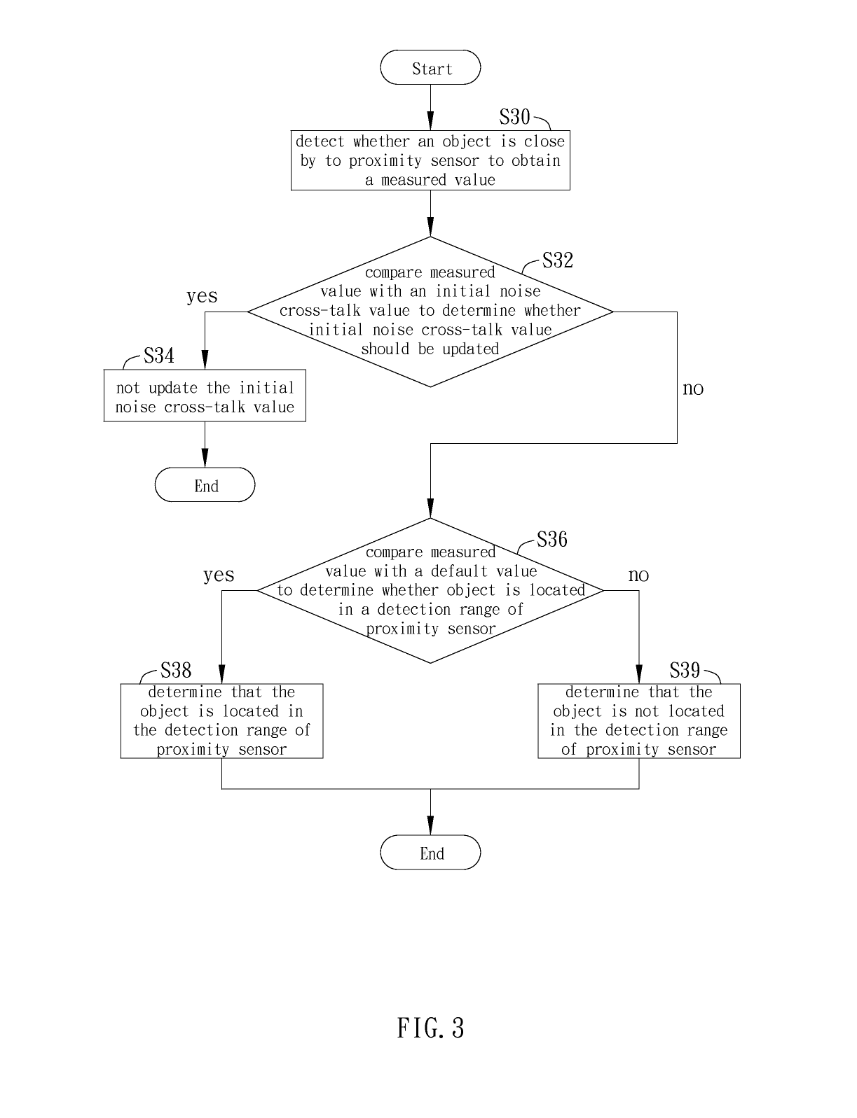

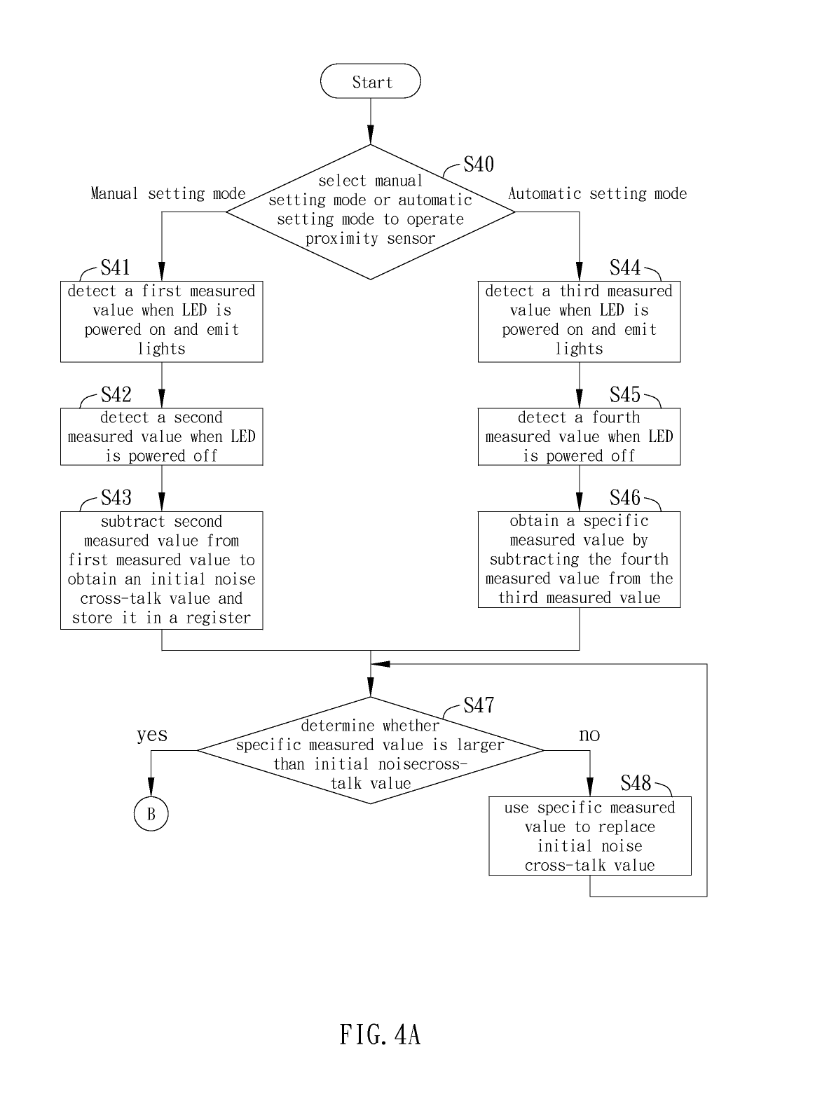

FIG. 3 illustrates a flowchart of the proximity sensor operating method in another embodiment of the invention.

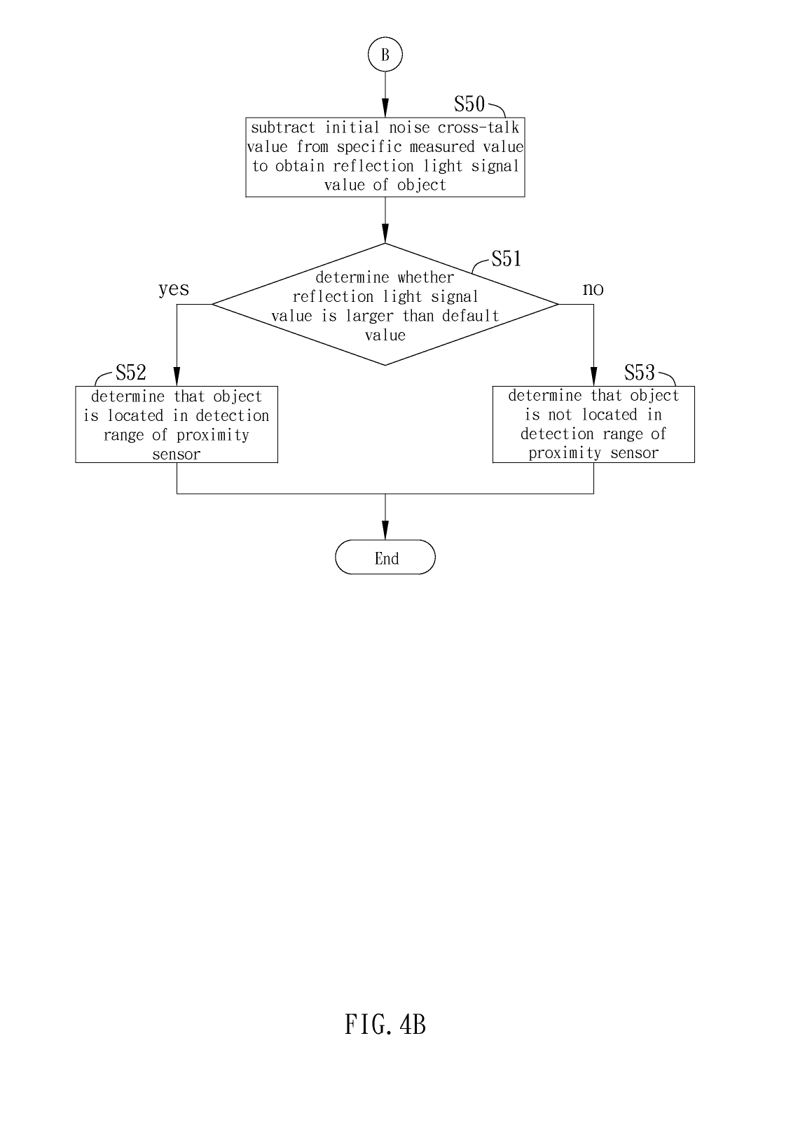

FIG. 4A and FIG. 4B illustrate flowcharts of the proximity sensor operating method in another embodiment of the invention.

### DETAILED DESCRIPTION OF THE INVENTION

A preferred embodiment of the invention is a proximity sensor. In practical applications, the proximity sensor can sense whether an object or obstacle is in front by optical or electromagnetic means; therefore, the proximity sensor can be used in a smart phone or handheld device to determine whether the user is close by to answer or used in a domestic robot to determine whether any furniture or person is in front. The invention can effectively reduce the noise crosstalk effect caused by poor packaging or mechanical design, so that the proximity sensor of the invention will not malfunction due to misjudgment.

Please refer to FIG. 1. FIG. 1 illustrates a functional block diagram of a proximity sensor in this embodiment. As shown in FIG. 1, the proximity sensor 1 includes a light emitter E and a light sensor R. The light emitter E includes a light-emitting diode LED used to emit lights. In fact, the light-emitting diode LED can be an infrared ray light-emitting diode (IR LED) used to emit infrared rays, but is not limited to this.

In this embodiment, the light sensor R can be an integrated circuit including at least one light sensing unit and a control circuit. In FIG. 1, the light sensor R includes a proximity sensing unit PS, an ambient light sensing unit ALS, a sensed light processing unit 10, an analog/digital converter 11, a temperature compensating unit 12, a digital signal processing unit 13, an inter-integrated circuit (I²C) interface 14, a buffer 15, a LED driver 16, an oscillator 17, and a reference value generator 18. The proximity sensing unit PS and the ambient light sensing unit ALS are coupled to the sensed light processing unit 10; the temperature compensating unit 12 is coupled to the sensed light processing unit 10; the analog/digital converter 11 is coupled to the sensed light processing unit 10, the digital signal processing unit 13, the I²C interface 14, and the oscillator 17 respectively; the digital signal processing unit 13 is coupled to the analog/digital converter 11, the I²C interface 14, the buffer 15, the LED driver 16, and the oscillator 17 respectively; the I²C interface 14 is coupled to the analog/digital converter 11, the digital signal processing unit 13, the LED driver 16, and the reference value generator 18 respectively; the oscillator 17 is coupled to the analog/digital converter 11, the digital signal processing unit 13, and the reference value generator 18 respectively; the reference value generator 18 is coupled to the I²C interface 14 and the oscillator 17 respectively.

In this embodiment, the ambient light sensing unit ALS is used to sense an ambient light intensity around the proximity sensor 1. The sensed light processing unit 10 is used to process the light signal sensed by the ambient light sensing unit ALS and the proximity sensing unit PS and to perform temperature compensation according to the temperature compensating unit 12. The LED driver 16 is used to drive the light-emitting diode LED. The oscillator 17 can be a quartz oscillator. The reference value generator 18 is used to generate a default reference value.

The user can use the I²C interface 14 to set digital signal processing parameters needed by the digital signal processing unit 13. When the object is close to the light sensor R, the lights emitted from the light-emitting diode LED will be reflected to the proximity sensing unit PS by the object, and then the reflected lights will be processed by the sensed light processing unit 10 and converted into digital light sensing signals by the analog/digital converter 11. Then, the digital signal processing unit 13 will determine whether the object is close to the light sensor R according to the digital light sensing signal.

If the result determined by the digital signal processing unit 13 is yes, the buffer 15 will output a proximity notification signal to inform the electronic apparatus including the proximity sensor 1 that the object is close to the electronic apparatus, so that the electronic apparatus can immediately make corresponding action. For example, a smart phone with the proximity sensor 1 will know that the face of the user is close to the smart phone according to the proximity notification signal; therefore, the smart phone will shut down the touch function of the touch monitor to avoid the touch monitor being carelessly touched by the face of the user.

However, the proximity sensor 1 may have noise crosstalk problem due to poor packaging or mechanical design, which may cause the digital signal processing unit 13 to make a misjudgment, and in turn causing the electronic apparatus, including the proximity sensor 1, to malfunction. For example, if when the face of the user is not close to the smart phone, but the digital signal processing unit 13 makes a misjudgment that an object is close to the smart phone, the smart phone will shut down the touch function of the touch monitor, and the user will not be able to user the touch function of the touch monitor. Therefore, the proximity sensor 1 of this embodiment has three operation modes described as follows to solve the aforementioned malfunction problem.

The first operation mode is a manual setting mode. After the electronic apparatus, including the proximity sensor 1, is assembled as shown in FIG. 2A and FIG. 2B under the condition that no object is close to the proximity sensor 1 of the electronic apparatus, if the proximity sensing unit PS senses a first measured value C1 when the light-emitting diode LED is active and emits the light L (see FIG. 2A) and senses a second measured value C2 when the light-emitting diode LED is inactive (see FIG. 2B), since the second measured value C2 may include noise and the first measured value C1 may include noise and noise cross-talk (e.g., the portion reflected by the glass G), the digital signal processing unit 13 can subtract the second measured value C2 from the first measured value C1 to obtain an initial noise cross-talk value CT under the condition that no object is close to the proximity sensor 1 of the electronic apparatus, and store the initial noise cross-talk value CT in a register (not shown in the figure) through the I²C interface 14. The initial noise cross-talk value CT can be used as a maximum threshold value of noise cross-talk in the system.

It should be noticed that since no object is close to the proximity sensor 1 of the electronic apparatus at this time, the initial noise cross-talk value CT obtained by the digital signal processing unit 13 should only include noise cross-talk values caused by the packaging and the mechanical portion of the system. Therefore, after the initial noise cross-talk value CT is obtained, whenever the proximity sensor 1 tries to detect whether the object is close to the proximity sensor 1, the digital signal processing unit 13 needs to subtract the initial noise cross-talk value CT from the measured value to effectively reduce the effect of noise cross-talk.

The second operation mode is an automatic setting mode. Whenever the electronic apparatus, including the proximity sensor 1, is active, the proximity sensor 1 can obtain the initial noise cross-talk value CT by subtracting the second measured value C2 from the first measured value C1 as mentioned above, and the initial noise cross-talk value CT can be used as a standard to determine that the sensed value is noise, noise cross-talk, or light signal reflected by the object.

As shown in FIG. 2C˜FIG. 2F, after the electronic apparatus including the proximity sensor 1 is active, the object 2 may be close to the proximity sensor 1 of the electronic apparatus, and the object 2 may be located in the detection range of the proximity sensor 1. If the proximity sensing unit PS senses a third measured value C3 when the light-emitting diode LED is active and emits the light L and senses a fourth measured value C4 when the light-emitting diode LED is inactive. Since the fourth measured value C4 may include the noise, and the third measured value C3 may include the noise, the noise cross-talk, and the light signal reflected by the object 2, the digital signal processing unit 13 can obtain a specific measured value M by subtracting the fourth measured value C4 from the third measured value C3, and the specific measured value M represents the noise cross-talk and the light signal reflected by the object 2.

Next, the digital signal processing unit 13 determines whether the specific measured value M is larger than the initial noise cross-talk value CT. If the result determined by the digital signal processing unit 13 is no, it means that the specific measured value M (the noise cross-talk and the light signal reflected by the object 2) at this time is smaller than the initial noise cross-talk value CT. Therefore, the proximity sensor 1 needs to replace the initial noise cross-talk value CT stored in the register with the specific measured value M through the I²C interface 14. Afterwards, when the proximity sensor 1 detects whether any object is close to the proximity sensor 1 again, the updated initial noise cross-talk value (the specific measured value M) will be used as a standard of determination.

If the result determined by the digital signal processing unit 13 is yes, it means that the specific measured value M (the noise cross-talk and the light signal reflected by the object 2) at this time is larger than the initial noise cross-talk value CT. Therefore, it is unnecessary to update the initial noise cross-talk value CT stored in the register. Then, the digital signal processing unit 13 will subtract the initial noise cross-talk value CT from the specific measured value M to obtain the reflection light signal value N of the object 2.

Afterwards, in order to determine whether the object 2 is located in the detection range of the proximity sensor 1, that is to say, to determine whether the object 2 is close enough to the proximity sensor 1, the digital signal processing unit 13 compares the reflection light signal value N of the object 2 with a default value N0 to determine whether the reflection light signal value N of the object 2 is larger than the default value N0. It should be noted that the default value N0 is the object detecting threshold value detected by the proximity sensor 1 when the object 2 is located at the boundary SB of the detection range of the proximity sensor 1.

If the result determined by the digital signal processing unit 13 is yes, that is to say, the reflection light signal value N of the object 2 is larger than the default value N0, it means that the strength of the light reflected by the object 2, reflecting the light of the light-emitting diode LED, is stronger than the strength of the light reflected by the object located at the boundary SB of the detection range of the proximity sensor 1, also reflecting the light of the light-emitting diode LED. Therefore, the proximity sensor 1 knows that the object 2 is located in the detection range of the proximity sensor 1; that is say, the object 2 is close enough to the proximity sensor 1, as shown in FIG. 2C and FIG. 2D. At this time, the buffer 15 will output a proximity notification signal to inform the electronic apparatus, including the proximity sensor 1, that the object 2 is approaching, so that the electronic apparatus can immediately make corresponding actions. For example, the electronic apparatus can shut down the touch function of its touch monitor.

If the result determined by the digital signal processing unit 13 is no, that is to say, the reflection light signal value N of the object 2 is not larger than the default value N0, it means that the strength of the light reflected by the object 2, reflecting the light of the light-emitting diode LED, is not stronger than the strength of the light reflected by the object located at the boundary SB of the detection range of the proximity sensor 1, reflecting the light of the light-emitting diode LED. Therefore, the proximity sensor 1 knows that the object 2 is not located in the detection range of the proximity sensor 1; that is to say, the object 2 is not close enough to the proximity sensor 1, as shown in FIG. 2E and FIG. 2F. Therefore, the buffer 15 will not output the proximity notification signal to inform the electronic apparatus, including the proximity sensor 1, that the object 2 is approaching, and the electronic apparatus will not make corresponding actions such as shutting down the touch function of its touch monitor.

The third operation mode is a selection setting mode. The user can use the I²C interface 14 to set a control bit for the user to freely choose between the manual setting mode and the automatic setting mode to reduce the effect of the noise crosstalk.

Another preferred embodiment of the invention is a proximity sensor operating method. Please refer to FIG. 3. FIG. 3 illustrates a flowchart of the proximity sensor operating method in this embodiment.

As shown in FIG. 3, in the step S30, the method detects whether an object is close by to the proximity sensor to obtain a measured value. Then, in the step S32, the method compares the measured value with an initial noise cross-talk value to determine whether the initial noise cross-talk value should be updated. Wherein, the initial noise cross-talk value is obtained by the proximity sensor operated under the manual setting mode. Under the manual setting mode, the proximity sensor obtains a first measured value when the light emitter is active and a second measured value when the light emitter is inactive, and subtracts the second measured value from the first measured value to obtain an initial noise cross-talk value.

If the result determined by the step S32 is yes, the method will perform the step S34, not to update the initial noise cross-talk value. If the result determined by the step S32 is no, the method will perform the step S36 to compare the measured value with a default value to determine whether the object is located in a detection range of the proximity sensor. Wherein, the default value is the object detecting threshold value detected by the proximity sensor when the object is located at the boundary of the detection range of the proximity sensor.

If the result determined by the step S36 is yes, the method will perform the step S38 to determine that the object is located in the detection range of the proximity sensor. If the result determined by the step S36 is no, the method will perform the step S39 to determine that the object is not located in the detection range of the proximity sensor.

Please refer to FIG. 4A and FIG. 4B. FIG. 4A and FIG. 4B illustrate flowcharts of the proximity sensor operating method in another embodiment. As shown in FIG. 4A and FIG. 4B, in the step S40, the method selects either the manual setting mode or the automatic setting mode to operate the proximity sensor. If the manual setting mode is selected, under the condition that no object is close by to the proximity sensor of the electronic apparatus, the method performs the step S41 to detect a first measured value C1 when the LED is active and emit lights and the step S42 to detect a second measured value C2 when the LED is inactive.

Since the second measured value C2 may include noise and the first measured value C1 may include noise and noise cross-talk, in the step S43, the method subtracts the second measured value C2 from the first measured value C1 to obtain an initial noise cross-talk value CT and store the initial noise cross-talk value CT in a register, and the initial noise cross-talk value CT is used as a maximum threshold value of noise cross-talk in the system.

If the automatic setting mode is used, after the electronic apparatus, including the proximity sensor, is active, the object may be close to the proximity sensor of the electronic apparatus. The method performs the step S44 to detect a third measured value C3 when the LED is active and emit lights and the step S45 to detect a fourth measured value C4 when the LED is inactive. Since the fourth measured value C4 may include the noise, and the third measured value C3 may include the noise, the noise cross-talk, and the light signal reflected by the object. Therefore, in the step S46, the method obtains a specific measured value M by subtracting the fourth measured value C4 from the third measured value C3, and the specific measured value M represents the noise cross-talk and the light signal reflected by the object.

Next, in the step S47, the method determines whether the specific measured value M is larger than the initial noise cross-talk value CT. If the result determined by the step S47 is no, it means that the specific measured value M (the noise cross-talk and the light signal reflected by the object 2) at this time is smaller than the initial noise cross-talk value CT. Therefore, in the step S48, the method uses the specific measured value M to replace the initial noise cross-talk value CT, so that the specific measured value M can be used as an updated initial noise cross-talk value. Later, when the method performs the step S47 again, the updated initial noise cross-talk value (the specific measured value M) will be used to compare with another specific measured value M′ obtained by the method performing the step S46 again to determine whether the specific measured value M′ is larger than the updated initial noise cross-talk value (the specific measured value M).

If the result determined by the step S47 is yes, it means that the specific measured value M (the noise cross-talk and the light signal reflected by the object) at this time is larger than the initial noise cross-talk value CT. Therefore, it is unnecessary to update the initial noise cross-talk value CT stored in the register. In the step S50, the method will subtract the initial noise cross-talk value CT from the specific measured value M to obtain the reflection light signal value N of the object.

Afterwards, in order to determine whether the object is located in the detection range of the proximity sensor; that is to say, to determine whether the object is close enough to the proximity sensor, in the step S51, the method will compare the reflection light signal value N of the object with a default value N0 to determine whether the reflection light signal value N of the object is larger than the default value N0. It should be noted that the default value N0 is the object detecting threshold value detected by the proximity sensor when the object is located at the boundary of the detection range of the proximity sensor.

If the result determined by the step S51 is yes, that is to say, the reflection light signal value N of the object is larger than the default value N0, it means that the strength of the reflected light generated by the object reflecting the light of the LED is stronger than the strength of the reflected light generated by the strength of the reflected light generated by the object located at the boundary of the detection range of the proximity sensor reflecting the light of the LED. Therefore, in the step S52, the method determines that the object is located in the detection range of the proximity sensor; that is say, the object is close enough to the proximity sensor. At this time, the proximity sensor will output a proximity notification signal to inform the electronic apparatus that the object is approaching, so that the electronic apparatus can immediately make corresponding action.

If the result determined by the step S51 is no, that is to say, the reflection light signal value N of the object is not larger than the default value N0, it means that the strength of the light reflected by the object, reflecting the light of the LED, is not stronger than the strength of the light reflected by the object located at the boundary of the detection range of the proximity sensor, also reflecting the light of the LED. Therefore, in the step S53, the method determines that the object is not located in the detection range of the proximity sensor; that is to say, the object is not close enough to the proximity sensor. Therefore, the buffer will not output the proximity notification signal to inform the electronic apparatus that the object is approaching.

Compared to the prior arts, the proximity sensor and the operating method thereof in the invention can effectively reduce the noise crosstalk effect caused by poor packaging or mechanical design, so that the proximity sensor of the invention will not malfunction due to misjudgment, and the sensing accuracy of the proximity sensor will be largely increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A proximity sensor, comprising:
a proximity sensing unit, for detecting whether an object is close by to obtain a measured value; and
a signal processing unit, coupled to the proximity sensing unit, for comparing the measured value with an initial noise cross-talk value to determine whether the initial noise cross-talk value should be updated,
wherein when the signal processing unit determines not to update the initial noise cross-talk value, the signal processing unit compares the measured value with a default value to determine whether the object is located in a detection range of the proximity sensing unit.

2. The proximity sensor of claim 1, wherein the initial noise cross-talk value is obtained when the proximity sensor is operated under a manual mode.

3. The proximity sensor of claim 2, further comprising a light emitter, wherein under the manual mode, the proximity sensing unit obtains a first measured value when the light emitter is active and obtains a second measured value when the light emitter is inactive, and the signal processing unit obtains the initial noise cross-talk value by subtracting the second measured value from the first measured value.

4. The proximity sensor of claim 1, wherein the default value is an object detection threshold detected by the proximity sensing unit when the object is located at a boundary of the detection range of the proximity sensing unit.

5. The proximity sensor of claim 1, wherein the signal processing unit determines that the measured value is not larger than the initial noise cross-talk value, the signal processing unit uses the measured value to update the initial noise cross-talk value.

6. A method of operating a proximity sensor, comprising steps of:
(a) detecting whether an object is close by to obtain a measured value;
(b) comparing the measured value with an initial noise cross-talk value to determine whether the initial noise cross-talk value should be updated; and
(c) if the result determined by the step (b) is no, comparing the measured value with a default value to determine whether the object is located in a detection range of the proximity sensor.

7. The method of claim 6, further comprising a step of:
operating the proximity sensor under a manual mode to obtain the initial noise cross-talk value.

8. The method of claim 7, wherein under the manual mode, the method further comprises steps of:
obtaining a first measured value when a light emitter is active;
obtaining a second measured value when the light emitter is inactive; and
obtaining the initial noise cross-talk value by subtracting the second measured value from the first measured value.

9. The method of claim 6, wherein the default value is an object detection threshold detected by the proximity sensor when the object is located at a boundary of the detection range of the proximity sensor.

10. The method of claim 6, wherein the step (b) further comprises steps of:
(b1) determining whether the measured value is larger than the initial noise cross-talk value;
(b2) if the result determined by the step (b1) is yes, no need to update the initial noise cross-talk value;
(b3) if the result determined by the step (b1) is no, using the measured value to update the initial noise cross-talk value.
